(19) United States
(12) Patent Application Publication
(10) Pub. No.: US 2004/0143057 A1
(43) Pub. Date: Jul. 22, 2004

(54) Use of polyglycerine esters and the alkoxylated and anionic derivatives thereof as emulsifiers in emulsions polymerisation

(76) Inventors: Hendrik Ahrens, Frankfurt am Main (DE); Uwe Falk, Bruchkoebel (DE)

Correspondence Address: CLARIANT CORPORATION, INTELLECTUAL PROPERTY DEPARTMENT, 4000 MONROE ROAD, CHARLOTTE, NC, 28205, US

(21) Appl. No.: 10/478,152

(22) PCT Filed: May 7, 2002
(86) PCT No.: PCT/EP02/05008

(30) Foreign Application Priority Data
May 19, 2001 (DE) 101 24 547.5

(51) Int. Cl. C08K 3/00

(52) U.S. Cl. 524/800

(57) ABSTRACT

The invention relates to the use of esters of polyglycerine with 2 to 100 glycerine units and at least one carboxylic acid with 6 to 42 carbon atoms as emulsifier in emulsion polymerisation.

The present invention relates to the use of fatty acid polyglycerol esters and alkoxylated and anionic derivatives thereof as emulsifiers in emulsion polymerizations.

The emulsifiers used for emulsion polymerization according to the prior art are mostly anionic and nonionic emulsifiers.

Customary anionic emulsifiers are sodium, potassium and ammonium salts of fatty acids, sodium alkylbenzenesulfonates, sodium alkylsulfonates, sodium olefinsulfonates, sodium polynaphthalenesulfonates, sodium dialkyl diphenyl ether disulfonates, sodium, potassium and ammonium alkyl sulfates, sodium, potassium and ammonium alkyl polyethylene glycol ether sulfates, sodium, potassium and ammonium alkylphenol polyethylene glycol ether sulfates, sodium, potassium and ammonium mono- and dialkyl sulfosuccinates and monoalkylpolyoxyethyl sulfosuccinates, and also alkyl polyethylene glycol ether phosphoric acid mono-, di- and triesters and their mixtures and alkylphenol polyethylene glycol ether phosphoric acid mono-, di- and triesters and their mixtures, and also their sodium, potassium and ammonium salts.

The nonionic emulsifiers used are customarily alkylphenol polyethylene glycol ethers, alkyl polyethylene glycol ethers, fatty acid polyethylene glycol ethers, ethylene/propylene glycol block polymers and sorbitan ester polyethylene glycol ethers.

Emulsion polymerizations are carried out using anionic and nonionic emulsifiers usually with the total batch as the initial charge or in a feed process in which only a small part of the monomers to be polymerized is initially introduced into the polymerization vessel and the larger part (50 to 100% by weight) is added during the progress of the polymerization. The anionic or nonionic emulsifiers are introduced as desired during emulsion polymerization in the feed or in the reactor initial charge, or are added subsequently to the prepared polymer dispersion for stabilization.

An object of the present invention was therefore to find novel emulsifiers for emulsion polymerization which ensure improved physicochemical stability of the emulsion polymers.

It has now been found that using fatty acid polyglycerol esters and alkoxylated and anionic derivatives thereof as emulsifiers in emulsion polymerization it is possible to prepare stable and low-coagulum polymer dispersions.

The invention thus provides for the use of esters between polyglycerol having 2 to 100 glycerol units and at least one carboxylic acid having 6 to 42 carbon atoms as emulsifier in emulsion polymerization.

Polyglycerols are compounds of the formula (1)

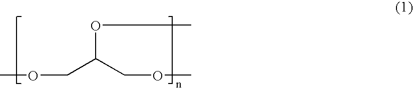

in which n is the degree of condensation. n here is between 2 and 100, preferably between 3 and 20.

The esters of polyglycerol are preferably prepared with carboxylic acids having 6 to 26, in particular 8 to 18, carbon atoms. The carboxylic acids may be aliphatic, aliphatic-unsaturated, cycloaliphatic, cycloaliphatic-unsaturated or aromatic. They are preferably monocarboxylic acids.

In a preferred embodiment, the carboxylic acids are native saturated fatty acids, such as caprylic acid, capric acid, lauric acid, myristic acid, palmitic acid, stearic acid, behenic acid, hexosanoic acid and montanic acid, native unsaturated carboxylic acids, such as oleic acid, linoleic acid, linolenic acid, rapeseed oil fatty acid and erucic acid, synthetic saturated carboxylic acids, such as margaric acid, cyclic carboxylic acids, such as naphthenic acid, benzoic acid, phenylacetic acid and resin acids, such as abietic acid, levopimaric acid and neoabietic acid.

Preferably, the esters contain polyglycerol and the carboxylic acid in the molar ratio of at least 1:1, in particular in the ratio 1:1 to 1:10, especially 1:1 to 1:5.

The processes for the preparation of polyglycerol and the esters of polyglycerol with fatty acids are known in the prior art.

The process for the preparation of polyglycerol esters is disclosed, for example, in DE 34 46 720 A1 on page 5, line 26 to page 11, line 4. Reference is expressly hereby made to the disclosure of this prior art.

In a further preferred embodiment of the invention, the esters are used in alkoxylated form. The alkoxylated esters of polyglycerols contain alkoxy groups, which may optionally be derivatized, on one or more of the free OH groups of polyglycerol.

In preferred embodiments, these are radicals of the formula (2)

—(A—O)ₓ—B (2)

in which A is C₂-C₄-alkylene, x is a number from 1 to 500, in particular 2 to 100 and B is hydrogen or the radical of a di- or polyhydric inorganic or organic acid which, as well as oxygen atoms, also has at least one phosphorus or sulfur atom.

Examples of inorganic acids which are suitable for forming the alkoxylated esters are sulfuric and phosphoric acid.

In a preferred embodiment, the organic or inorganic acids used for the esterification of the alkoxy groups according to formula (2) are di- or trihydric.

In a preferred embodiment, the organic acids are di-, tri- or polyhydric carboxylic acids, i.e. compounds which contain 2, 3 or more carboxyl groups and which moreover also have at least one sulfur- or phosphorus-containing functional group. Particular preference is given to sulfur-containing functional groups, especially sulfonate groups.

The particularly preferred sulfonic acids/sulfonates can be aliphatic or aromatic compounds. Preferred sulfonic acids/sulfonates contain 2 or 3 carboxyl groups, and including the carboxyl groups, 3 to 6 carbon atoms. A particularly preferred sulfonic acid is sulfosuccinic acid.

The units (A—O) can be uniform or mixed alkoxy units. Mixed alkoxy units can be present in a random or block arrangement.

Corresponding to the above statements, the radicals of the formula (2) may, for example, be:

a) a hydrogen atom,

b) a polyethylene glycol radical of the formula (3)

—(CH₂—CH₂—O)_{b}—H (3)

in which b is a number from 1 to 500,

c) a polyalkylene glycol radical of the formula (4)

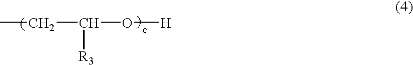

in which R₃ is a methyl group or ethyl group and c is a number from 1 to 100,

d) or a polyalkylene glycol radical of the formula (5)

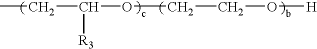

in which R₃ is a methyl group or ethyl group, b is a number from 1 to 500 and c is a number from 1 to 100, and the ethylene glycol, propylene glycol and butylene glycol units are arranged in random or blockwise distribution within the polyalkylene glycol ether radical,

e) a polyethylene glycol ether sulfuric ester of the formula (6)

—(CH₂—CH₂—O)_{b}—SO₃Me (6)

in which b is a number from 1 to 500 and Me is a sodium, potassium or ammonium ion,

f) or a polyethylene glycol ether phosphoric ester of the formula (7)

—(CH₂—CH₂—O)_{b}—PO₃H₂ (7)

in which b is a number from 1 to 500,

g) a polyethylene glycol ether sulfosuccinic half-ester (polyethylene glycol ether sulfosuccinate) of the formula (8)

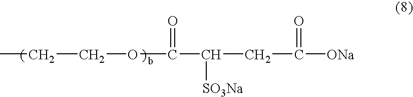

in which b is a number from 1 to 500.

The alkoxylated esters of polyglycerol can be prepared by reacting such an ester with a C₂-C₄-alkylene oxide in the presence of an alkaline catalyst such as, for example, KOH, NaOH, potassium methoxide or sodium methoxide at temperatures between 120 and 200° C.

The anionically derivatized esters of polyglycerol can be prepared by reacting the alkoxylated esters of polyglycerol with suitable acids. The preparation of sulfate esters is preferably carried out with amidosulfonic acid instead of with sulfuric acid. Phosphoric acid can be used for the preparation of phosphoric esters. Organic acids are preferably reacted in the form of their anhydrides with the alcohols of the formula 1. The insertion of functional groups preferably takes place following the preparation of the ester of the nonfunctionalized acid. Thus, the preparation of the sulfosuccinic esters can be carried out by preparing the corresponding maleic esters and subsequent sulfonation e.g. with pyrosulfites.

The invention further provides a process for the preparation of polymer dispersions in which olefinically unsaturated monomers are polymerized in the presence of the esters of polyglycerol.

The monomers used for the preparation of polymer dispersions according to the emulsion polymerization process are, for example,

vinyl monomers, such as carboxylic esters of vinyl alcohol, for example vinyl acetate, vinyl propionate, vinyl ethers of isononanoic acid or of isodecanoic acid,

aryl-substituted olefins, such as styrene and stilbene

olefinically unsaturated carboxylic esters, such as methyl acrylate, ethyl acrylate, propyl acrylate, n-butyl acrylate, isobutyl acrylate, pentyl acrylate, hexyl acrylate, 2-ethylhexyl acrylate, hydroxyethyl acrylate, and the corresponding methacrylic esters,

olefinically unsaturated dicarboxylic esters, such as dimethyl maleate, diethyl maleate, dipropyl maleate, dibutyl maleate, dipentyl maleate, dihexyl maleate and di-2-ethylhexyl maleate,

olefinically unsaturated carboxylic acids and dicarboxylic acids, such as acrylic acid, methacrylic acid, itaconic acid, maleic acid and fumaric acid and their sodium, potassium and ammonium salts,

olefinically unsaturated sulfonic acids and phosphonic acids and their alkali metal and ammonium salts, such as acrylamidomethylpropanesulfonic acid and their alkali metal and ammonium, alkyl ammonium and hydroxyalkyl ammonium salts, allylsulfonic acid and their alkali metal and ammonium salts, acryloyloxyethylphosphonic acid and its ammonium and alkali metal salts, and the corresponding methacrylic acid derivatives,

olefinically unsaturated amines, ammonium salts, nitriles and amides, such as dimethylaminoethyl acrylate, acryloyloxyethyltrimethyl-ammonium halides, acrylonitrile, N-methacrylamide, N-ethylacrylamide, N-propylacrylamide, N-methylolacrylamide, and the corresponding methacrylic acid derivatives and vinylmethylacetamide.

In a preferred embodiment, the abovementioned monomers are polymerized with further comonomers, preferably olefins or halogenated olefins having 2 to 8 carbon atoms, such as, for example, ethylene, propene, butenes, pentenes, 1,3-butadiene, chloroprene, vinyl chloride, vinylidene chloride, vinylidene fluoride and tetrafluoroethylene.

To prepare the polymer dispersions, the water-immiscible monomers are generally finely distributed in the aqueous phase in the form of micelles using the emulsifiers according to the invention, and the free-radical polymerization reaction is started by initiators such as, for example, ammonium peroxodisulfate, sodium peroxodisulfate and potassium peroxodisulfate.

Further auxiliaries and additives for the use with the emulsifiers according to the invention may be protective colloids, such as carboxymethylcellulose, hydroxyethylcellulose, methylhydroxy-propylcellulose, and partially and completely saponified polyvinyl alcohol.

A review of common processes, surfactants and further auxiliaries of emulsion polymerization is given by Peter A. Lovell and Mohamed S. El-Aasser, in “Emulsion Polymerization and Emulsion Polymers”, published by John Wiley and Sons, 1997.

The fatty acid polyglycerol esters according to the invention and alkoxylated and anionic derivatives thereof can be used during the emulsion polymerization by initially introducing them into the reaction vessel prior to the start of the polymerization reaction, or by adding them to the reaction vessel during the polymerization reaction. Another alternative is the addition after the polymerization reaction has finished to improve the stability of the polymer dispersion.

The fatty acid polyglycerol esters according to the invention and alkoxylated and anionic derivatives thereof can either be used on their own or else in combination with other already known anionic and nonionic emulsifiers of the prior art, as have been described in the introduction. The amount of anionic and nonionic emulsifiers of the prior art is then preferably 0.05 to 5% by weight, in particular 0.08 to 3% by weight and particularly preferably 0.1 to 2% by weight, based on the weight of the water-insoluble sparingly water-soluble monomers.

In general, the esters of polyglycerol according to the invention and alkoxylated and anionic derivatives thereof are used as emulsifiers in amounts of from 0.1 to 10% by weight, preferably 0.2 to 5% by weight, in particular 0.4 to 4% by weight, based on the weight of the water-insoluble or sparingly water-soluble monomers used for the preparation of the polymer dispersion.

The polymer dispersions prepared using the esters of polyglycerol according to the invention and alkoxylated and anionic derivatives thereof exhibit low coagulum formation during and after polymerization and an improvement in the shear stability, temperature stability and storage stability, the freeze/thaw stability and the electrolyte stability toward divalent and trivalent cations such as calcium, barium and aluminum. In addition, an improvement in the film properties of the polymer films prepared from the polymer dispersions is observed. The polymer dispersions prepared using the esters of polyglycerol according to the invention form films with low water absorption, low blushing upon contact with water and good wet and dry rubbing fastnesses.

### EXAMPLES

1. Vinyl Acetate Dispersion

1700 g of a monomer emulsion consisting of 473.2 g of demineralized water, 2.8 g of Netzer SB 10 (65% strength solution of sodium diisodecylsulfosuccinate in a water/isopropanol mixture, Clariant GmbH), 24 g of an ethoxylated diglycerol monolaurate having 10 mol of ethylene oxide according to the invention (®Hostacerin DGL, Clariant GmbH), 300 g of ®VeoVa10 (vinyl isodecanoate, Shell) and 900 g of vinyl acetate, and an initiator solution consisting of 3.6 g of potassium peroxodisulfate and 304.4 g of demineralized water.

356.9 g of demineralized water were initially introduced into a 3 liter reaction vessel, and 2.8 g of Netzer SB 10 (65% strength solution of sodium diisodecylsulfosuccinate in a water/isopropanol mixture), 24.0 g of ®Tylose H 200 YG4 (hydroxyethyocellulose, Clariant GmbH), 6.0 g of borax, 2.6 ml of acetic acid, 170 g of the monomer dispersion prepared above and 92.3 g of the initiator solution were successively added with stirring using an anchor stirrer. The emulsion was then heated to 76° C. in a water bath under a nitrogen atmosphere, so that the free-radical polyaddition reaction starts. The reaction temperature was kept constant at 79 to 81° C. by cooling or heating over the water bath. After 15 minutes, the remaining 1530 g of the monomer emulsion were added over a period of 3 hours. To initiate the free-radical polyaddition reaction, the remaining 215.7 g of the initiator solution were added via a second feed over the course of a period of 3 hours and 15 minutes. The reaction mixture was then stirred for 2 hours at 80° C. with stirring and under a nitrogen atmosphere and then cooled to room temperature. For preservation, 3.6 g of ®Nipacide Cl15 (Nipa Laboratories Ltd.) were added to the prepared polymer dispersion.

The resulting polymer dispersion had a solids content of 50% and a coagulum of <0.010% through a 100 μm sieve and of <0.015% through a 40 μm sieve.

2. Straight Acrylate Dispersion

1800 g of a monomer emulsion consisting of 341.2 g of demineralized water, 72.3 g of Emulsogen EPA 07 (sodium alkyl polyethylene glycol ether sulfate, Clariant GmbH), 20.3.9 of an ethoxylated diglycerol monolaurate having 10 mol of ethylene oxide according to the invention (®Hostacerin DGL, Clariant GmbH), 2.2 g of dodecyl mercaptan, 150 g of methyl methacrylate, 350 g of 2-ethylhexyl acrylate, 850 g of n-butyl acrylate and 14 g of methacrylic acid, and 57 g of an initiator solution consisting of 7.1 g of ammonium peroxodisulfate and 49.9 g of demineralized water were prepared.

263 g of demineralized water were initially introduced into a 3 liter reaction vessel and heated to 80° C. over a water bath under a nitrogen atmosphere. 17 g of the initiator solution were then added, and the continuous addition of the 1800 g of monomer emulsion and the remaining 40 g of initiator solution were immediately started. The metered addition of the two components was carried out with continuous stirring using an anchor stirrer and under a nitrogen atmosphere over the course of a period of 3 hours. The reaction mixture was then heated at 80° C. for a further hour and then cooled to room temperature. The pH of the prepared polymer dispersion was adjusted to pH 7 to 8 using 12.5% strength ammonia solution.

The resulting polymer dispersion had a solids content of 65% and a coagulum of <0.050% through a 100 μm sieve and of <0.080% through a 40 μm sieve.

3. Vinyl Acetate Dispersion by the Monomer Addition Process

710.6 g of water were initially introduced into a glass flask, and 23.3 g of ®Tylose H 200 YG4 (hydroxyethylcellulose, Clariant GmbH), 5.7 g of borax, 20 g of ®Emulsogen EPA 073 (sodium alkyl ether sulfate, Clariant GmbH), 23.3 g of an ethoxylated diglycerol monolaurate according to the invention having 10 mol of ethylene oxide (®Hostacerin DGL, Clariant GmbH) and 2.4 ml of acetic acid were added and stirred. 100 g of 1.17% strength aqueous potassium peroxodisulfate solution and 117 g of a mixture of 75% vinyl acetate and 25% ®VeoVa10 (vinyl isodecanoate, Shell) were metered in and the mixture was heated to 76° C. The polymerization mixture was stirred for 15 minutes, the temperature increasing to >80° C. Then, over a period of 150 minutes, 1049 g of a mixture of 75% vinyl acetate and 25% ®VeoVa10 (vinyl isodecanoate, Shell) were metered in. At the same time, the metered addition of 149 g of a 1.17% strength aqueous potassium peroxodisulfate solution was started. The metered addition of the aqueous potassium peroxodisulfate solution lasted 175 minutes. The polymerization mixture was heat-treated at 80° C. by cooling or by supplying heat. After a post-polymerization time of one hour at 80° C., the polymer dispersion was cooled to room temperature. For preservation, 3.3 g of ®Nipacide Cl15 (Nipa Laboratories Ltd.) were added to the prepared polymer dispersion.

The resulting polymer dispersion had a solids content of 54% and a coagulum of <0.10% through a 100 μm sieve.

1. The use of esters between polyglycerol having 2 to 100 glycerol units and at least one carboxylic acid having 6 to 42 carbon atoms as emulsifier in emulsion polymerization.

2. The use as claimed in claim 1, where the carboxylic acids have 6 to 26 carbon atoms.

3. The use as claimed in claim 1 and/or 2, where the esters carry radicals of the formula (2)
—(A—O)ₓ—B (2)
in which A is C₂-C₄-alkylene, x is a number from 1 to 500, and B is .hydrogen or the radical of a di- or polyhydric inorganic or organic acid which, as well as oxygen atoms, also has at least one phosphorus or sulfur atom.

4. The use of compounds as claimed in one or more of claims 1 to 3, wherein the compounds are used in combination with anionic emulsifiers chosen from the group consisting of
sodium, potassium and ammonium salts of fatty acids
sodium alkylsulfonates,
sodium olefinsulfonates,
sodium alkylbenzenesulfonates,
sodium polynaphthalenesulfonates,
sodium dialkyl diphenyl ether disulfonates,
sodium, potassium and ammonium alkyl sulfates,
sodium, potassium and ammonium alkyl polyethylene glycol ether sulfates,
sodium, potassium and ammonium alkylphenol polyethylene glycol ether sulfates,
sodium, potassium and ammonium mono- and dialkylsulfosuccinates and monoalkylpolyoxyethyl sulfosuccinates, and
alkyl polyethylene glycol ether phosphoric acid mono-, di- and triesters and their mixtures and alkylphenol polyethylene glycol ether phosphoric acid mono-, di- and triesters and their mixtures and their sodium, potassium and ammonium salts.

5. The use of compounds as claimed in one or more of claims 1 to 4, wherein the compounds are used in combination with nonionic emulsifiers chosen from the group consisting of
alkylphenol polyethylene glycol ethers,
alkyl polyethylene glycol ethers,
fatty acid polyethylene glycol ethers,
ethylene/propylene glycol block polymers and
sorbitan ester polyethylene glycol ethers.

6. A process for the preparation of emulsion polymers by polymerizing olefinically unsaturated monomers in an aqueous medium in the presence of esters of polyglycerol as claimed in one or more of claims 1 to 5, or by adding these esters to the polymer after polymerization.

7. The process for the preparation of emulsion polymers as claimed in claim 6, in which the esters of polyglycerol are used in amounts of from 0.1 to 10% by weight, based on the weight of the water-insoluble or sparingly water-soluble monomers used for the preparation of the polymer dispersion.

8. The process for the preparation of emulsion polymers as claimed in claim 6 and/or 7, in which the esters of polyglycerol are used in combination with other nonionic and anionic emulsifiers, where the amount of the nonionic and anionic emulsifiers is 0.05 to 5% by weight, based on the weight of the water-insoluble or sparingly water-soluble monomers.
